(19) United States
(12) Patent Application Publication
(10) Pub. No.: US 2023/0239860 A1
(43) Pub. Date: Jul. 27, 2023

(54) Coordinating User Equipment Selection

(71) Applicant: Google LLC, Mountain View, CA (US)

(72) Inventors: Jibing Wang, San Jose, CA (US); Erik Richard Stauffer, Sunnyvale, CA (US)

(73) Assignee: Google LLC, Mountain View, CA (US)

(21) Appl. No.: 17/997,792

(22) PCT Filed: Apr. 28, 2021
(86) PCT No.: PCT/US2021/029734

§ 371 Date: Nov. 2, 2022

Related U.S. Application Data
(60) Provisional application No. 63/022,904, filed on May 11, 2020.

(51) Int. Cl. H04W 72/121; H04W 56/00

(52) U.S. Cl. CPC H04W 72/121; H04W 56/0015; H04W 92/10

(57) ABSTRACT

Methods, devices, systems, and means for selection of a coordinating user equipment, UE, in a user equipment-coordination set, UECS, that facilitates selection of the coordinating UE by the UEs in the UECS are described herein. Sharing of the role of coordinating UE by UEs in the UECS can be scheduled in a round-robin manner. Selection criteria can be used to determine which one or more UEs in the UECS will offer better performance in the role of coordinating UE.

### BACKGROUND

Generally, a provider of a wireless network manages wireless communications over the wireless network. For example, a base station manages a wireless connection with a user equipment (UE) that is connected to the wireless network. The base station determines configurations for the wireless connection, such as bandwidth, timing, and protocol for the wireless connection.

The quality of service between the UE and the base station can be degraded by a number of factors, such as loss in signal strength, bandwidth limitations, interfering signals, and so forth. This is particularly true for UEs operating at a cell edge, which are frequently troubled by weak signal quality. A number of solutions have been developed to address cell-edge issues occurring in certain wireless communication systems. However, techniques to form a user equipment-coordination set lack capabilities to form a user equipment-coordination set under circumstances when the user equipment is unable to individually connect to a base station.

### SUMMARY

This summary is provided to introduce simplified concepts of coordinating user equipment selection. The simplified concepts are further described below in the Detailed Description. This summary is not intended to identify essential features of the claimed subject matter nor is it intended for use in determining the scope of the claimed subject matter.

In aspects, methods, devices, systems, and means for a first user equipment (UE) joining a first user equipment-coordination set (UECS) in a wireless communications network are described in which the first user equipment receives an indication of an allocation of air interface resources for UECS synchronization signals. The first UE monitors the air interface resources for UECS synchronization signals and receives, from a second UE acting as a coordinating UE for the first UECS, one or more UECS synchronization signals for the first UECS. The first UE transmits a first UECS-Access-Request to the second UE and receives a first UECS-Access-Response from the second UE, the first UECS-Access-Response indicating that the first UE is included in the first UECS.

### BRIEF DESCRIPTION OF THE DRAWINGS

The details of one or more aspects of coordinating user equipment selection are described below. The use of the same reference numbers in different instances in the description and the figures indicate similar elements:

FIG. 1 illustrates an example operating environment in which aspects of coordinating user equipment selection can be implemented.

FIG. 2 illustrates an example device diagram of a user equipment and a serving cell base station.

FIG. 3 illustrates an example block diagram of a wireless network stack model in which various aspects of coordinating user equipment selection can be implemented.

FIG. 4 illustrates an example environment in which various aspects of coordinating user equipment selection can be implemented.

FIG. 5 illustrates example data and control transactions between devices of a user equipment-coordination set for scheduling user equipments as the coordinating user equipment of the user equipment-coordination set in accordance with aspects of coordinating user equipment selection.

FIG. 6 illustrates additional example data and control transactions between devices of a user equipment-coordination set for a handover of user equipment from a first user equipment-coordination set to a second user equipment-coordination set in accordance with aspects of coordinating user equipment selection.

FIG. 7 illustrates an example method of coordinating user equipment selection as generally related to scheduling user equipments as the coordinating user equipment of the user equipment-coordination set in accordance with aspects of the techniques described herein.

### DETAILED DESCRIPTION

This document describes techniques and apparatuses for selecting a coordinating user equipment (UE) in a user equipment-coordination set (UECS) by the UEs in the UECS. Sharing of the role of coordinating UE by UEs in the UECS can be scheduled in a round-robin manner. Selection criteria can be used to determine which one or more UEs in the UECS will offer better performance in the role of coordinating UE.

A UECS is formed by multiple UEs assigned as a group to function together, similarly to a distributed antenna, for the benefit of a particular UE (e.g., target UE). The UECS includes a coordinating UE that coordinates joint transmission and reception of downlink and/or uplink signals for the target UE or multiple target UEs in the UECS. By combining antennas and transmitters of multiple UEs in the UECS, the effective transmit power of the target UE is significantly increased, and the effective signal quality is greatly improved.

Multiple UEs can each receive downlink data transmissions from the base station. Unlike conventional relay techniques, these UEs do not decode the downlink transmissions into data packets and then forward the data packets to a destination. Rather, the UEs demodulate and sample the downlink transmissions to produce I/Q samples. The UEs determine where to forward the I/Q samples of the downlink transmissions, such as to a coordinating UE for decoding. Note that a single UE may simultaneously have the roles of a coordinating UE and a target UE. In aspects, the target UE may be included in a subset of target UEs within the UECS. The coordinating UE receives the I/Q samples from the other UEs in the UECS and stores the I/Q samples in a buffer memory for decoding. However, if the target UE is the coordinating UE, then the target UE does not wirelessly forward the I/Q samples to itself. Then, the coordinating UE synchronizes and decodes the stored I/Q samples into data packets for transmission to the target UE(s). Accordingly, the processing of the I/Q samples occurs at the coordinating UE. In this way, the UECS acts as a distributed antenna for the target UE.

Several UEs may be able to monitor a base station but individually each UE is unable to reliably communicate with the base station. In this circumstance, the several UEs can form a UECS to communicate with the base station without the base station determining the configuration of the UECS and/or without the base station selecting a coordinating UE for the UECS. In the absence of a configuration from the base station, the UEs in the UECS require a technique for selecting a coordinating UE for the UECS, especially in the event that none of the UEs indicates a preference to be the coordinating UE.

In one aspect, a number of UEs in the UECS can take turns acting as the coordinating UE for the UECS. For example, the UEs can use round-robin scheduling to assign time intervals (time quanta) to the UEs, where each UE in the schedule acts as the coordinating UE for a time interval (time quantum) before the next UE in the schedule acts as the coordinating UE for the next time interval in the schedule. In other examples, UEs can be scheduled based on operational parameters, such as an amount of energy consumed performing coordinating UE tasks or an amount of uplink data transmitted (or downlink data received) while operating as the coordinating UE.

In alternative or additional aspects, one or more characteristics of UEs in the UECS can be used to select the coordinating UE or to select a subset of UEs to participate in round-robin scheduling. For example, the one or more characteristics include a battery and/or charging state, received-uplink feedback from a base station, uplink transmit power from the UE, signal strength of signals received from a base station, uplink throughput of the UE, sidelink throughput of the UE, and/or a number of base stations receiving uplink signals from the UE.

Many UEs are mobile devices and a UE may move in or out of range of other UEs. For example, a UE may be part of a first UECS formed with other UEs in a moving bus. When the user of the UE disembarks the bus, the UE moves out of range of the other UEs in the first UECS. The UE then needs to find other UEs that are already members of another UECS or with which the UE can form another UECS. In further aspects, the coordinating UE of the UECS periodically broadcasts synchronization signals that identify the current coordinating UE to the other UEs in the UECS. A UE that is searching for a UECS to join can receive the synchronization signal and request to join the UECS. In another aspect, when a first coordinating UE of a first UECS receives a synchronization signal from a second coordinating UE of a second UECS, the first coordinating UE can stop transmitting its synchronization signal and join the second UECS. Additionally, the first coordinating UE can handover its associated UEs to the second UECS.

### Example Environments

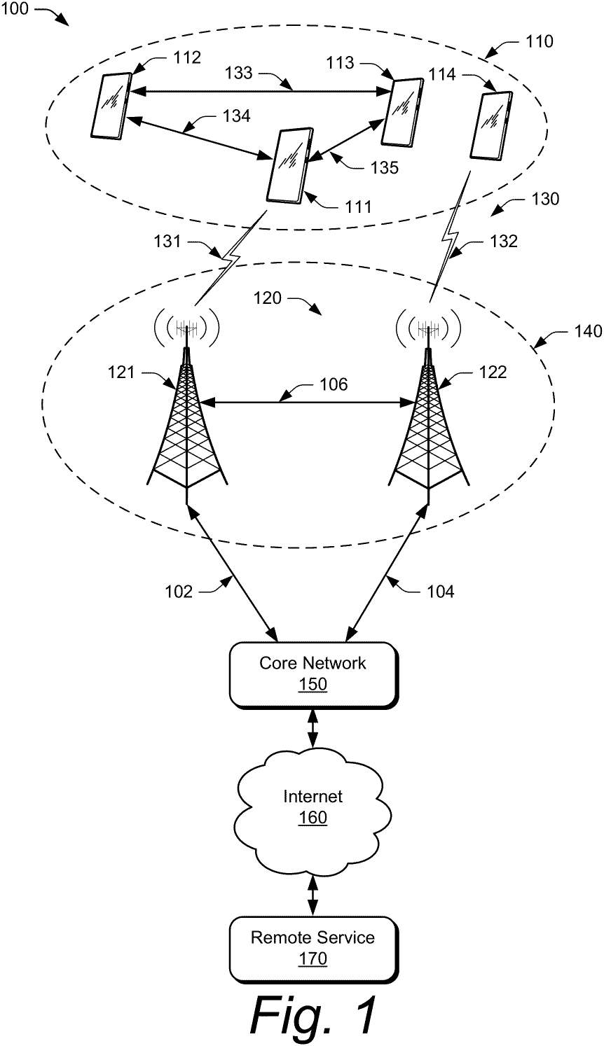

FIG. 1 illustrates an example environment 100, which includes multiple user equipment 110 (UE 110), illustrated as UE 111, UE 112, UE 113, and UE 114. When in communication range of a base station, each UE 110 can communicate with one or more base stations 120 (illustrated as base stations 121 and 122) through one or more wireless communication links 130 (wireless link 130), illustrated as wireless links 131 and 132. When individual UEs, such as the UE 111, the UE 112, and the UE 113 are individually out of communication range of a base station, those UEs can form a UECS and use joint-transmission and joint-reception to communicate with a base station. Each UE 110 in a UECS (illustrated as UE 111, UE 112, and UE 113) can communicate with a coordinating UE of the UECS and/or a target UE in the UECS through one or more local wireless network connections (e.g., WLAN, Bluetooth, NFC, a personal area network (PAN), WiFi-Direct, IEEE 802.15.4, ZigBee, Thread, millimeter wavelength communication (mmWave), or the like) such as local wireless network connections 133, 134, and 135. Although illustrated as a smartphone, the UE 110 may be implemented as any suitable computing or electronic device, such as a mobile communication device, a modem, cellular phone, gaming device, navigation device, media device, laptop computer, desktop computer, tablet computer, smart appliance, vehicle-based communication system, an Internet-of-things (IoT) device (e.g., sensor node, controller/actuator node, combination thereof), and the like. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, distributed base station or the like, or any combination or future evolution thereof.

The base stations 120 communicate with a UECS or a user equipment 110 using the wireless links 131 and 132, respectively, which may be implemented as any suitable type of wireless link. The wireless links 131 and 132 include control and data communication, such as downlink of data and control information communicated from the base stations 120 to the user equipment 110, uplink of other data and control information communicated from the user equipment 110 to the base stations 120, or both. The wireless links 130 may include one or more wireless links (e.g., radio links) or bearers implemented using any suitable communication protocol or standard, or combination of communication protocols or standards, such as 3rd Generation Partnership Project Long-Term Evolution (3GPP LTE), Fifth Generation New Radio (5G NR), and so forth. Multiple wireless links 130 may be aggregated in a carrier aggregation to provide a higher data rate for the UE 110. Multiple wireless links 130 from multiple base stations 120 may be configured for Coordinated Multipoint (CoMP) communication with the UE 110.

The base stations 120 are collectively a Radio Access Network 140 (e.g., RAN, Evolved Universal Terrestrial Radio Access Network, E-UTRAN, 5G NR RAN, or NR RAN). The base stations 121 and 122 in the RAN 140 are connected to a core network 150. The base stations 121 and 122 connect, at 102 and 104 respectively, to the core network 150 through an NG2 interface for control-plane signaling and using an NG3 interface for user-plane data communications when connecting to a 5G core network, or using an S1 interface for control-plane signaling and user-plane data communications when connecting to an Evolved Packet Core (EPC) network. The base stations 121 and 122 can communicate using an Xn Application Protocol (XnAP) through an Xn interface or using an X2 Application Protocol (X2AP) through an X2 interface, at 106, to exchange user-plane and control-plane data. The user equipment 110 may connect, via the core network 150, to public networks, such as the Internet 160 to interact with a remote service 170.

### Example Devices

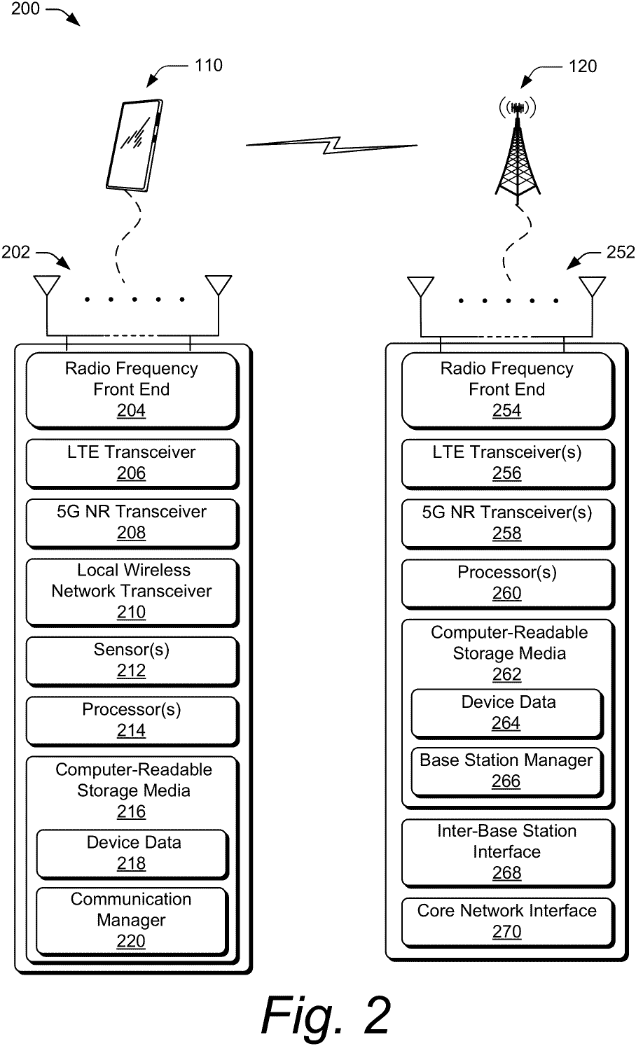

FIG. 2 illustrates an example device diagram 200 of a user equipment and a base station. In aspects, the device diagram 200 describes devices that can implement various aspects of coordinating user equipment selection. Included in FIG. 2 are the multiple UE 110 and the base stations 120. The multiple UE 110 and the base stations 120 may include additional functions and interfaces that are omitted from FIG. 2 for the sake of clarity. The UE 110 includes antennas 202, a radio frequency front end 204 (RF front end 204), and radio-frequency transceivers (e.g., an LTE transceiver 206 and a 5G NR transceiver 208) for communicating with base stations 120 in the 5G RAN 141 and/or the E-UTRAN 142. The UE 110 includes one or more additional transceivers (e.g., local wireless network transceiver 210) for communicating over one or more wireless local wireless networks (e.g., WLAN, Bluetooth, NFC, a personal area network (PAN), WiFi-Direct, IEEE 802.15.4, ZigBee, Thread, mmWave, or the like) with at least the coordinating UE of the UECS. The RF front end 204 of the UE 110 can couple or connect the LTE transceiver 206, the 5G NR transceiver 208, and the local wireless network transceiver 210 to the antennas 202 to facilitate various types of wireless communication.

The antennas 202 of the UE 110 may include an array of multiple antennas that are configured similar to or differently from each other. The antennas 202 and the RF front end 204 can be tuned to, and/or be tunable to, one or more frequency bands defined by the 3GPP LTE and 5G NR communication standards and implemented by the LTE transceiver 206, and/or the 5G NR transceiver 208. Additionally, the antennas 202, the RF front end 204, the LTE transceiver 206, and/or the 5G NR transceiver 208 may be configured to support beamforming for the transmission and reception of communications with the base stations 120. By way of example and not limitation, the antennas 202 and the RF front end 204 can be implemented for operation in sub-gigahertz bands, sub-6 GHz bands, and/or above 6 GHz bands that are defined by the 3GPP LTE and 5G NR communication standards. In addition, the RF front end 204 can be tuned to, and/or be tunable to, one or more frequency bands defined and implemented by the local wireless network transceiver 210 to support transmission and reception of communications with other UEs in the UECS over a local wireless network.

The UE 110 includes sensor(s) 212 can be implemented to detect various properties such as temperature, supplied power, power usage, battery state, or the like. As such, the sensors 212 may include any one or a combination of temperature sensors, thermistors, battery sensors, and power usage sensors.

The UE 110 also includes processor(s) 214 and computer-readable storage media 216 (CRM 216). The processor 214 may be a single core processor or a multiple core processor composed of a variety of materials, such as silicon, polysilicon, high-K dielectric, copper, and so on. The computer-readable storage media described herein excludes propagating signals. CRM 216 may include any suitable memory or storage device such as random-access memory (RAM), static RAM (SRAM), dynamic RAM (DRAM), non-volatile RAM (NVRAM), read-only memory (ROM), or Flash memory useable to store device data 218 of the UE 110. The device data 218 includes user data, multimedia data, beamforming codebooks, applications, and/or an operating system of the UE 110, which are executable by processor(s) 214 to enable user-plane communication, control-plane signaling, and user interaction with the UE 110.

CRM 216 also includes a communication manager 220 (e.g., a communication manager application 220). Alternately or additionally, the communication manager 220 may be implemented in whole or part as hardware logic or circuitry integrated with or separate from other components of the UE 110. In at least some aspects, the communication manager 220 configures the RF front end 204, the LTE transceiver 206, the 5G NR transceiver 208, and/or the local wireless network transceiver 210 to implement the techniques described herein for coordinating user equipment selection.

The device diagram for the base stations 120, shown in FIG. 2, includes a single network node (e.g., a gNode B). The functionality of the base stations 120 may be distributed across multiple network nodes or devices and may be distributed in any fashion suitable to perform the functions described herein. The base stations 120 include antennas 252, a radio frequency front end 254 (RF front end 254), one or more LTE transceivers 256, and/or one or more 5G NR transceivers 258 for communicating with the UE 110. The RF front end 254 of the base stations 120 can couple or connect the LTE transceivers 256 and the 5G NR transceivers 258 to the antennas 252 to facilitate various types of wireless communication. The antennas 252 of the base stations 120 may include an array of multiple antennas that are configured similar to or differently from each other. The antennas 252 and the RF front end 254 can be tuned to, and/or be tunable to, one or more frequency band defined by the 3GPP LTE and 5G NR communication standards, and implemented by the LTE transceivers 256, and/or the 5G NR transceivers 258. Additionally, the antennas 252, the RF front end 254, the LTE transceivers 256, and/or the 5G NR transceivers 258 may be configured to support beamforming, such as Massive-MIMO, for the transmission and reception of communications with any UE 110 in a UECS.

The base stations 120 also include processor(s) 260 and computer-readable storage media 262 (CRM 262). The processor 260 may be a single core processor or a multiple core processor composed of a variety of materials, such as silicon, polysilicon, high-K dielectric, copper, and so on. CRM 262 may include any suitable memory or storage device such as random-access memory (RAM), static RAM (SRAM), dynamic RAM (DRAM), non-volatile RAM (NVRAM), read-only memory (ROM), or Flash memory useable to store device data 264 of the base stations 120. The device data 264 includes network scheduling data, radio resource management data, beamforming codebooks, applications, and/or an operating system of the base stations 120, which are executable by processor(s) 260 to enable communication with the UE 110.

CRM 262 also includes a base station manager 266 (e.g., base station manager application 266). Alternately or additionally, the base station manager 266 may be implemented in whole or part as hardware logic or circuitry integrated with or separate from other components of the base stations 120. In at least some aspects, the base station manager 266 configures the LTE transceivers 256 and the 5G NR transceivers 258 for communication with the UE 110, as well as communication with a core network. The base stations 120 include an inter-base station interface 268, such as an Xn and/or X2 interface, which the base station manager 266 configures to exchange user-plane and control-plane data between another base station 120, to manage the communication of the base stations 120 with the UE 110. The base stations 120 include a core network interface 270 that the base station manager 266 configures to exchange user-plane and control-plane data with core network functions and entities.

### Network Stack

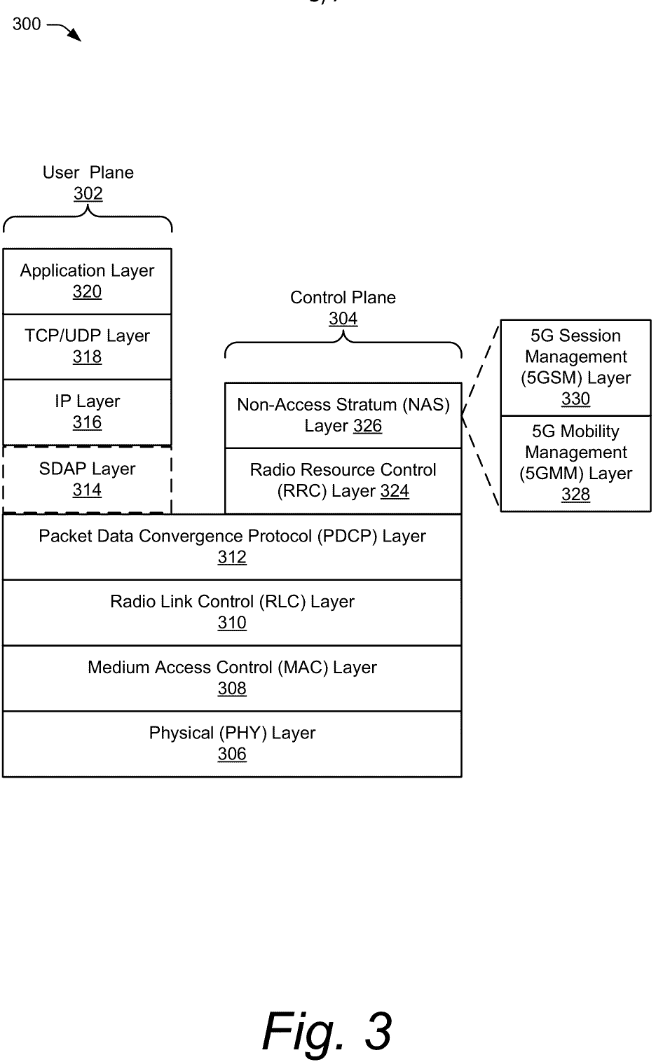

FIG. 3 illustrates an example block diagram 300 of a wireless network stack model 300 (stack 300). The stack 300 characterizes a communication system for the example environment 100, in which various aspects of coordinating user equipment selection can be implemented. The stack 300 includes a user plane 302 and a control plane 304. Upper layers of the user plane 302 and the control plane 304 share common lower layers in the stack 300. Wireless devices, such as the UE 110 or the base station 120, implement each layer as an entity for communication with another device using the protocols defined for the layer. For example, a UE 110 uses a Packet Data Convergence Protocol (PDCP) entity to communicate to a peer PDCP entity in a base station 120 using the PDCP.

The shared lower layers include a physical (PHY) layer 306, a Medium Access Control (or Media Access Control) (MAC) layer 308, a Radio Link Control (RLC) layer 310, and a PDCP layer 312. The PHY layer 306 provides hardware specifications for devices that communicate with each other. As such, the PHY layer 306 establishes how devices connect to each other, assists in managing how communication resources are shared among devices, and the like.

The MAC layer 308 specifies how data is transferred between devices. Generally, the MAC layer 308 provides a way in which data packets being transmitted are encoded and decoded into bits as part of a transmission protocol.

The RLC layer 310 provides data transfer services to higher layers in the stack 300. Generally, the RLC layer 310 provides error correction, packet segmentation and reassembly, and management of data transfers in various modes, such as acknowledged, unacknowledged, or transparent modes.

The PDCP layer 312 provides data transfer services to higher layers in the stack 300. Generally, the PDCP layer 312 provides transfer of user plane 302 and control plane 304 data, header compression, ciphering, and integrity protection.

Above the PDCP layer 312, the stack splits into the user-plane 302 and the control-plane 304. Layers of the user plane 302 include an optional Service Data Adaptation Protocol (SDAP) layer 314, an Internet Protocol (IP) layer 316, a Transmission Control Protocol/User Datagram Protocol (TCP/UDP) layer 318, and an application layer 320, which transfers data using the wireless link 106. The optional SDAP layer 314 is present in 5G NR networks. The SDAP layer 314 maps a Quality of Service (QoS) flow for each data radio bearer and marks QoS flow identifiers in uplink and downlink data packets for each packet data session. The IP layer 316 specifies how the data from the application layer 320 is transferred to a destination node. The TCP/UDP layer 318 is used to verify that data packets intended to be transferred to the destination node reached the destination node, using either TCP or UDP for data transfers by the application layer 320. In some implementations, the user plane 302 may also include a data services layer (not shown) that provides data transport services to transport application data, such as IP packets including web browsing content, video content, image content, audio content, or social media content.

The control plane 304 includes a Radio Resource Control (RRC) layer 324 and a Non-Access Stratum (NAS) layer 326. The RRC layer 324 establishes and releases connections and radio bearers, broadcasts system information, or performs power control. The RRC layer 324 also controls a resource control state of the UE 110 and causes the UE 110 to perform operations according to the resource control state. Example resource control states include a connected state (e.g., an RRC connected state) or a disconnected state, such as an inactive state (e.g., an RRC inactive state) or an idle state (e.g., an RRC idle state). In general, if the UE 110 is in the connected state, the connection with the base station 120 is active. In the inactive state, the connection with the base station 120 is suspended. If the UE 110 is in the idle state, the connection with the base station 120 is released. Generally, the RRC layer 324 supports 3GPP access but does not support non-3GPP access (e.g., WLAN communications).

The NAS layer 326 provides support for mobility management (e.g., using a Fifth-Generation Mobility Management (5GMM) layer 328) and packet data bearer contexts (e.g., using a Fifth-Generation Session Management (5GSM) layer 330) between the UE 110 and entities or functions in the core network, such as the Access and Mobility Management Function 152 (AMF 152) of the 5GC 150 or the like. The NAS layer 326 supports both 3GPP access and non-3GPP access.

In the UE 110, each layer in both the user plane 302 and the control plane 304 of the stack 300 interacts with a corresponding peer layer or entity in the base station 120, a core network entity or function, and/or a remote service, to support user applications and control operation of the UE 110 in the RAN 140.

### User Equipment-Coordination Set

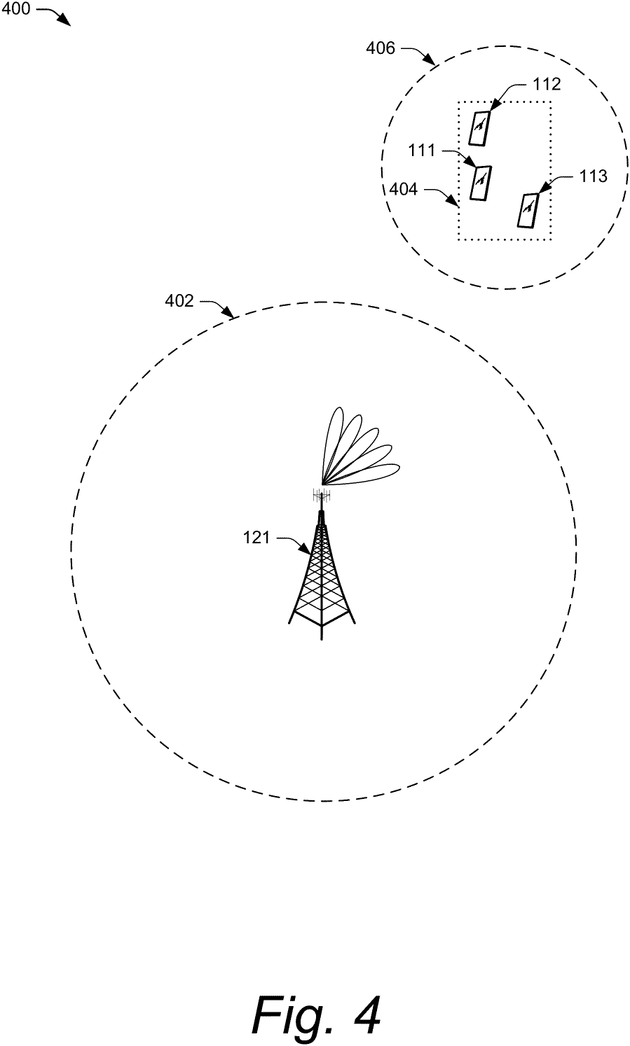

FIG. 4 illustrates an example implementation 400 of coordinating user equipment selection. The illustrated example includes a base station 121, UE 111, UE 112, and UE 113. Although, for the sake of illustration clarity, the UECS in FIG. 4 is illustrated as including three UEs, any number of UEs greater than one may be included in a UECS. In an example, each of the UEs illustrated in FIG. 4 has limited transmit power which may result in difficulty transmitting uplink data to the base station 121. This may be due, at least partially, to the UEs being outside a communication range 402 of the cell provided by the base station 121 or the UEs being in a transmission-challenged location (e.g., a basement, urban canyon, etc.) such that the individual UEs lacks a sufficient link budget to communicate with the base station 121. Alternatively or additionally, each of the UEs illustrated in FIG. 4 may have difficulty reliably receiving downlink signals from the base station 121 because, for example, the UEs are outside the communication range 402 of the cell or in a reception-challenged location.

Using the techniques described herein, a set of UEs (e.g., the UE 111, UE 112, and UE 113) can form a UECS (e.g., the UECS 404) using air interface resources allocated within the RAN 140 to synchronize and form a UECS. Based on a user input or predefined setting, each of the UEs may opt in or out of participation in the UECS. An effective transmit power of the target UE 112 can increase significantly (e.g., linearly) with the number of UEs in the UECS, which can greatly improve a link budget of the target UE 112.

In addition, UE coordination can be based on spatial beams or timing advance, or both, associated with each UE. For example, for beamforming or Massive-MIMO, it may be desirable that all the UEs within the UECS are able to receive the same signal from the base station. Therefore, all the UEs within the UECS may be geographically near one another, e.g., within a threshold distance of a coordinating UE in the UECS. In this way, the UEs in the UECS may each be in the same beam or beams that are close to each other. Timing advance may indicate a distance between a UE and the base station. A similar timing advance for each UE in a group indicates that those UEs are approximately the same distance from the base station. UEs within a predefined distance of one another that are all a similar distance from the base station may be capable of working together in a UECS in a distributed fashion to improve a signal strength and quality to the benefit of a target UE in the UECS.

Communication among the UEs can occur using a local wireless network 406, such as a PAN, NFC, Bluetooth, WiFi-Direct, local mmWave link, etc. In this example, all three of the UEs 111, 112, 113 receive RF signals from the base station 121. The UE 111, UE 112, and UE 113 demodulate the RF signals to produce baseband I/Q analog signals and sample the baseband I/Q analog signals to produce I/Q samples. The UE 112 and the UE 113 forward the I/Q samples along with system timing information (e.g., system frame number (SFN)) using the local wireless network 406 to the coordinating UE 111 using the local wireless network transceiver 210. The coordinating UE 111 then uses the timing information to synchronize and combine the I/Q samples and processes the combined signal to decode data packets for the target UE 112. The coordinating UE 111 then transmits the data packets to the target UE 112 using the local wireless network 406.

When the target UE 112 has uplink data to send to the base station 121, the target UE transmits the uplink data to the coordinating UE 111 that uses the local wireless network 406 to distribute the uplink data, as I/Q samples, to each UE in the UECS 404. The base station 121 receives the j ointly-transmitted uplink data from the UEs 111, 112, 113 and processes the combined signal to decode the uplink data from the target UE 112.

### Coordinating User Equipment Scheduling

A set of UEs 110 may be able to monitor a base station 121 but individually each UE 110 is unable to reliably communicate with the base station 121. In this circumstance, the set of UEs 110 can form a UECS to communicate with the base station 121 without the base station 121 determining the configuration of the UECS and/or selecting a coordinating UE for the UECS. While various criteria (discussed below) may be used to determine the best candidate UE to become the coordinating UE, there may be instances where the UEs in the UECS share the role of the coordinating UE by scheduling multiple UEs to act as the coordinating UE based on a criteria such as time slots, power consumed performing coordinating UE operations, and/or an amount of data transferred while acting as the coordinating UE.

In one aspect, a number of UEs in the UECS use round-robin scheduling to assign time intervals to the UEs where each UE in the schedule acts as the coordinating UE for a time interval before the next UE in the schedule acts as the coordinating UE for the next time interval in the schedule. To facilitate scheduling, every UE 110 in the UECS has a unique identifier within the UECS. For example, the unique identifier can be assigned to each UE in the order that the UE joins the UECS. In another example, the unique identifier can be an address assigned to the local wireless network interface of the UE, such as a MAC address, an IEEE Extended Unique Identifier (EUI), a physical layer address of the local wireless network interface, or the like. In further example the unique identifier can be an address assigned to the UE, such as an International Mobile Equipment Identity (IMEI) or the like. Additionally, to reduce overhead for communication within the UECS, short addressing can be used where the short address is derived from a longer universally unique identifier (e.g., an EUI or an IMEI).

In one aspect of round-robin scheduling, each UE 110 in the UECS serves as the coordinating UE sequentially based on the unique identifier of the UE. For example, each UE 110 serves as the coordinating UE for a fixed period of time (e.g., for 10 seconds) then the next UE 110 in the sequence serves as the coordinating UE. The scheduling of UEs as coordinating UE continues until each UE in the UECS has served as the coordinating UE, then the round-robin schedule continues from the first UE in the sequence.

In one option, if a UE 110 serves as the coordinating UE, that UE can choose not to participate in the joint transmission to and/or joint reception from the base station 121 in order to save that UE’s battery capacity (e.g., by not turning on its power amplifier to transmit to the base station). In another option, the amount of time each UE 110 serves as the coordinating UE can be logged by the UECS to enable load-balancing within the round-robin schedule to assure that no single UE or subset of UEs serves as the coordinating UE for an excessive amount of time. In a further option, the remaining battery capacity of each UE 110 in the UECS can be logged by the UECS to enable load-balancing within the round-robin schedule to assure that no UE or subset of UEs depletes its battery charge due to service as the coordinating UE.

In another aspect of round-robin scheduling, each UE 110 in the UECS sequentially serves as the coordinating UE until that UE has expended an amount of energy (e.g., a predetermined amount of energy) related to performing the operations of the coordinating UE, then the next UE 110 in the sequence serves as the coordinating UE. In a further aspect of round-robin scheduling, each UE 110 in the UECS sequentially serves as the coordinating UE until that UE has communicated an amount of data (e.g., a predetermined amount of data transferred over the local wireless network, the cellular network, or both) related to performing the operations of the coordinating UE, then the next UE 110 in the sequence serves as the coordinating UE.

When the current coordinating UE decides to transfer the role of coordinating UE to another UE 110 (a new coordinating UE), the current coordinating UE sends one or more broadcast Coordinator-Change messages to all UEs 110 in the UECS to indicate that the other UE 110 is the new coordinating UE, after which the new coordinating UE can start transmitting the synchronization signal for the UECS and the previous coordinating UE stops transmitting the synchronization signal. The current coordinating UE can determine to transfer the coordination role based on the reaching a value of the round-robin scheduling parameter (e.g., end of its time period, reaching a level of power consumed performing coordinating UE operations, and/or an amount of data transferred while acting as the coordinating UE), or the current coordinating UE can determine to delay the transfer until after completing a UECS operation that is in progress (e.g., joint processing, a joint transmission and/or a joint reception) to avoid interrupting and/or increasing the latency of the UECS operation. Optionally or additionally, scheduling-related information (e.g., the current round-robin schedule, logged parameters for UEs in the round-robin schedule, or the like) can be included in the broadcast message(s) or be forwarded directly from the previous coordinating UE to the new coordinating UE.

### Coordinating User Equipment Selection

One or more characteristics of UEs 110 in the UECS can be used to select the coordinating UE or to select a subset of UEs to participate in round-robin scheduling. In one aspect a battery and/or charging state of each of the UEs can be used to select a UE. For example, a UE 110 with the greatest remaining battery charge can be selected as the coordinating UE, or one or more UEs 110 that exceed a threshold value for remaining battery charge can be selected to be round-robin scheduled as the coordinating UE. In another example, one or more UEs that are externally powered or are connected to a battery charger can be selected instead of UEs 110 that are operating from battery power.

In another aspect, an uplink or downlink state of each UE can be used to select a UE 110 as the coordinating UE.For example, the UE 110 that delivers the most uplink signal power to the base station 121 and/or receives the strongest downlink signals, such as broadcast signals, from the base station 121 is selected as coordinating UE. In a further example, one or more UEs 110 that exceed a threshold value or have the highest N values for an uplink (e.g., uplink signal power) and/or downlink (e.g., received downlink signal strength) state can be selected to be round-robin scheduled as the coordinating UE.

In a further aspect, an uplink transmit power can be used to select a UE 110 as the coordinating UE to reduce overall transmit power interference in the RAN 140. For example, the UE 110 that requires the least transmit power to communicate with the base station 121 is selected as coordinating UE.In a further example, one or more UEs 110 that are below a threshold value for uplink transmit power or have the lowest N values for uplink transmit power can be selected to be round-robin scheduled as the coordinating UE.

In another aspect, a number of base stations that receive an uplink from a UE can be used to select a UE 110 as the coordinating UE. For example, the UE 110 that is able to reach the greatest number of base stations is chosen as the coordinating UE.When using CoMP communication, this UE 110 is the UE that has the best uplink. In a further example, one or more UEs 110 that exceed a threshold value or have the highest N values for the number of base station uplinks can be selected to be round-robin scheduled as the coordinating UE.

In a further aspect, the UE 110 with the highest uplink or sidelink data throughput is selected as the coordinating UE. In a further example, one or more UEs 110 that exceed a threshold value or have the highest N values for uplink or sidelink data throughput can be selected to be round-robin scheduled as the coordinating UE.

### UECS Synchronization

In aspects, the coordinating UE within the UECS periodically broadcasts synchronization signals to advertise the existence of the coordinating UE. The synchronization signals advertise the current coordinating UE when round-robin scheduling is used, indicate that a coordinating UE is available for any UE that is searching for a UECS to join, or can be used by another coordinating UE to determine to discontinue operating as a coordinating UE.

The UECS synchronization signal has a specific format in time, frequency, and/or code resources such that other UEs 110 can detect the UECS synchronization signal that is transmitted by the coordinating UE. The UECS synchronization signal can include an identifier of the coordinating UE and/or the UECS being coordinated by that coordinating UE. UEs 110 in a UECS, or searching for a UECS to join, monitor air interface resources allocated to the synchronization signals to maintain or establish a connection with the UECS. For example, the UECS synchronization signal is transmitted every 10 milliseconds using the specified air interface resources. For example, the RAN 140 (e.g., the base station 121) can allocate air interface resources for use by UECSs. The RAN 140 can allocate the air interface resources in one or more radio bands supported by the RAN 140. The RAN 140 can allocate one or more sets of air interface resources to enable multiple UECSs to operate within the RAN 140. The configuration of the UECS air interface resources can be provided to the UEs 110 using any suitable means such as broadcast messages from the base stations 121 in the RAN 140, in System Information Blocks (SIBs), or the like. In another example, the RAN 140 may indicate a configuration for UECS synchronization signals in an unlicensed radio band, such as a radio band used for WLAN communication, to enable UEs to form and synchronize using radio spectrum other than the licensed spectrum used by the RAN 140.

In another aspect, a first coordinating UE (with its own associated UEs) monitors air interface resources allocated for use by UECSs, and if the first coordinating UE detects synchronization signals from a second coordinating UE of a second UECS, the first coordinating UE can choose to stop acting as a coordinating UE (e.g., stop transmitting the UECS synchronization signal). The first coordinating UE can join the second UECS and can, optionally or additionally, hand over the UEs associated with the first UECS to the second UECS.

In a further aspect, synchronization signals can be used to avoid having multiple UEs acting as the coordinating UE for a UECS. For example, a first coordinating UE for a UECS monitors air interface resources allocated for use by UECSs, and if the first coordinating UE transmits a UECS synchronization signal and then detects synchronization signals from a second coordinating UE that identifies that the second coordinating UE is the coordinator for the same UECS as the first coordinating UECS, the first coordinating UE terminates acting as the coordinating UE for the UECS (e.g., stop transmitting the UECS synchronization signal).

In aspects, any UE 110 that is searching for a UECS to join monitors the air interface resources allocated by the RAN 140 for UECS synchronization signals. If the UE 110 detects the synchronization signals of a coordinating UE, the UE 110 can join the UECS of that coordinating UE. For example, the UE 110 can transmit a LTECS-Access-Request message or signal to the coordinating UE to request to join the UECS. The UE 110 can transmit the LTECS-Access-Request message or signal at a preestablished time interval after the received synchronization signal or at any random time between synchronization signals. Optionally, the coordinating UE 110 can transmit a UECS-Access-Response message or signal to the joining UE 110 indicating that the request to join the UECS has been accepted. Further, if the joining UE 110 fails to receive the UECS-Access-Response (e.g., because of interference or a collision with a UECS-Access-Request message or signal transmitted by a third UE), the joining UE 110 can retry joining the UECS, such as by using a backoff-and-retry technique where the joining UE determines a random backoff time before retransmitting the UECS-Access-Request message or signal to avoid collisions with another UE attempting to join the UECS. After the UE 110 has joined the UECS, the newly joined UE 110 can start participating in selection and/or round-robin scheduling to act as the coordinating UE for the UECS.

In another aspect, if a UE 110 loses its connection to the coordinating UE (e.g., the coordinating UE is powered off by a user), the UE 110 waits for a random time interval and monitors the air interface resources allocated by the RAN 140 for UECS synchronization signals to determine if there is a new coordinating UE for the UECS. If the UE 110 does not detect a synchronization signal for the UECS, the UE 110 may decide to become the coordinating UE by periodically transmitting synchronization signals for the UECS, or the UE 110 may decide to form a new UECS by transmitting synchronization signals that identify the new UECS. After the UE 110 becomes the coordinating UE for the existing UECS or the new UECS, round-robin scheduling of UEs to act as coordinating UE can follow. Optionally or additionally, the coordinating UE, without other UEs in the UECS, can vary the timing of transmitting the synchronization signal, such as to slow down synchronization signal transmissions to reduce power consumption by the coordinating UE.

### Data and Control Transactions

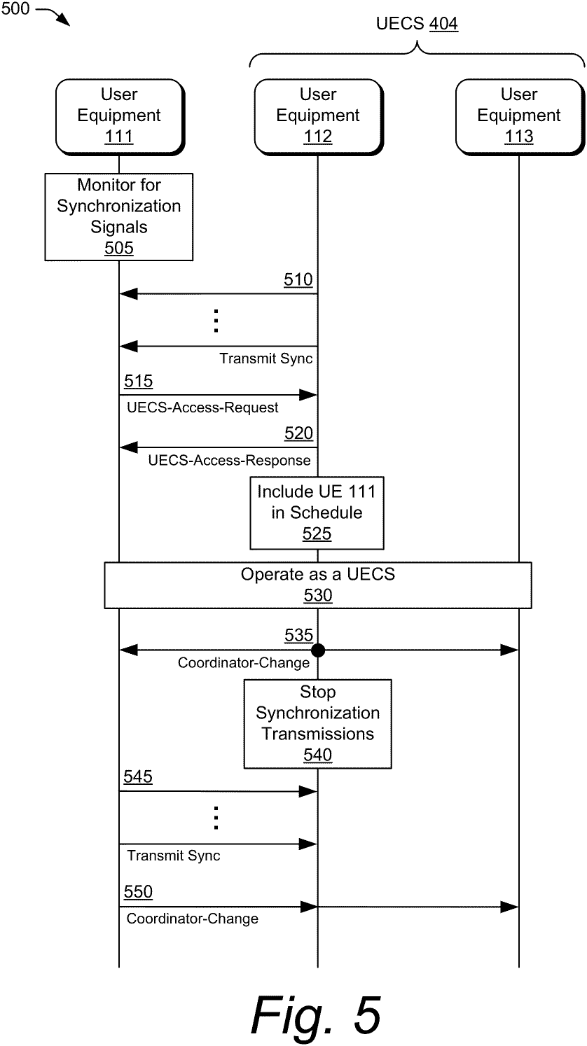

FIG. 5 illustrates data and control transactions between devices of a user equipment-coordination set for scheduling UEs as the coordinating UE of the UECS in accordance with aspects of coordinating user equipment selection. Although not illustrated for the sake of illustration clarity, various acknowledgements for messages illustrated in FIG. 5 may be implemented to ensure reliable operations of coordinating user equipment selection.

At 505, the UE 111 is searching for a UECS to join. UE 112 and UE 113 are members of the UECS 404, with the UE 112 currently acting as the coordinating UE for the UECS 404. To locate a UECS to join, the UE 111 monitors the air interface resources allocated by the RAN 140 for UECS synchronization signals.

At 510, the UE 112 in its role as the coordinating UE periodically transmits UECS synchronization signals for the UECS using the air interface resources allocated by the RAN 140 for UECS synchronization signals. Although not illustrated for the sake of clarity, the UE 112 periodically transmits synchronization signals for the UECS from the time it assumes the role of coordinating UE until it stops acting as the coordinating UE.

At 515, after receiving one or more UECS synchronization signals for the UECS 404, the UE 111 transmits a UECS-Access-Request to the UE 112 to request to join the UECS 404. At 520, the UE 112 sends a LTECS-Access-Response message to the UE 111 indicating whether or not the coordinating UE 112 has included the UE 111 in the UECS 404. If the coordinating UE 112 determines not to include the UE 111 in the UECS 404, the UE 111 can continue to search for UECS synchronization signals for another UECS to join (not illustrated in FIG. 5) or retry joining the UECS 404 (not illustrated in FIG. 5).

At 525, assuming that the UE 112 decides to include the UE 111 in the UECS 404, the UE 112 includes the UE 111 in a round-robin schedule of UEs that can act as coordinating UE for the UECS 404. As described above, various criteria may be used to determine if the UE 111 is capable of acting as the coordinating UE. Optionally, the UE 112, as the coordinating UE, may evaluate one or more criteria to determine whether to include or exclude the UE 111 in the round-robin schedule.

At 530, the UE 111, the UE 112, and the UE 113 operate as a UECS performing such operations as j oint-transmission, joint reception, and/or joint-processing. At 535, based on the round-robin schedule, the UE 112 concludes its turn acting as the coordinating UE by broadcasting a Coordinator-Change message to the other UEs in the UECS 404. The Coordinator-Change message includes an indication that UE 111 is the new coordinating UE for the UECS 404. Optionally or additionally, the Coordinator-Change message can include additional information such as the logged parameters described above, a current copy of the round-robin schedule, or the like. At 540, after transmitting the Coordinator-Change message, the UE 112 stops transmitting UECS synchronization signals for the UECS 404.

At 545, the UE 111 starts periodically transmitting synchronization signals for the UECS 404 using the air interface resources allocated by the RAN 140 for UECS synchronization signals. At 550, based on the round-robin schedule, the UE 111 concludes its turn acting as the coordinating UE by broadcasting a Coordinator-Change message to the other UEs in the UECS 404. The Coordinator-Change message includes an indication that UE 113 is the new coordinating UE for the UECS 404, and (not shown) the UE 111 stops transmitting UECS synchronization signals. The UE 113 begins periodically transmitting synchronization signals for the UECS 404, and the round-robin scheduling continues while the UECS 404 is in operation.

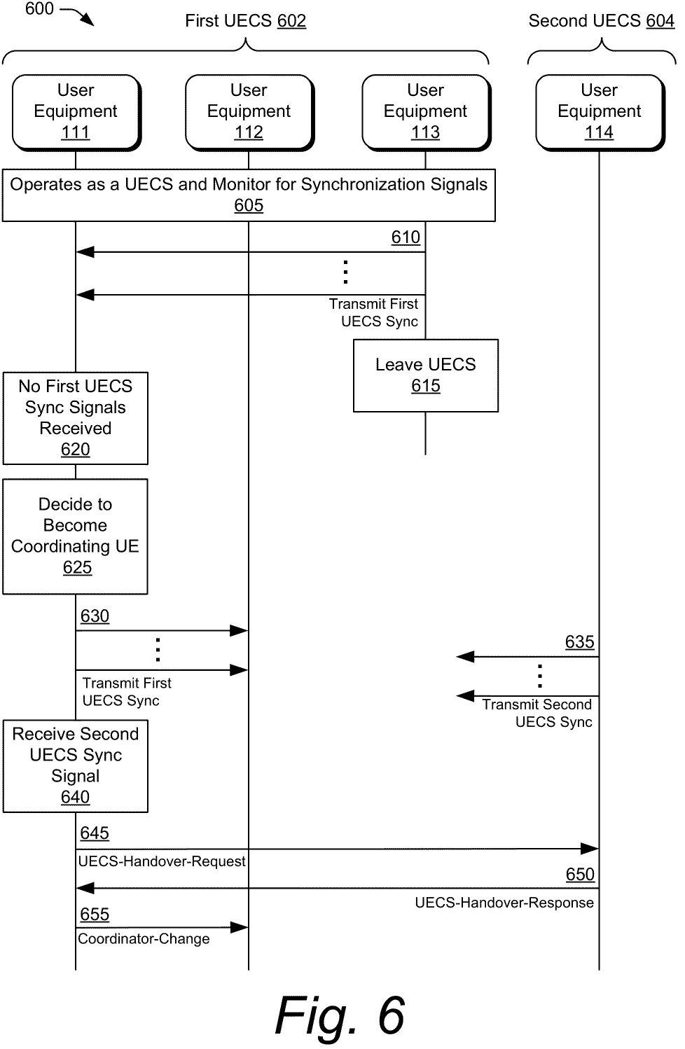

FIG. 6 illustrates data and control transactions between devices of a user equipment-coordination set for a handover of UEs from a first UECS to a second UECS in accordance with aspects of coordinating user equipment selection. Although not illustrated for the sake of illustration clarity, various acknowledgements for messages illustrated in FIG. 6 may be implemented to ensure reliable operations of coordinating user equipment selection.

At 605, the UE 111, the UE 112, and the UE 113 operate as a first UECS as described above, and the UE 114 is the coordinating UE of a second UECS 604 that may include additional UEs not illustrated in FIG. 6 for the sake of clarity. At 610, the UE 113 is acting as the coordinating UE for the first UECS 602 and transmits UECS synchronization signals for the first UECS 602.

At 615, the UE 113 leaves the first UECS 602. For example, the UE 113 has turned off or the UE 113 moves out of local wireless communication range of the first UECS 602. At 620 and based on monitoring the air interface resources allocated by the RAN 140 for UECS synchronization signals, the UE 111 determines that it has not received, for a threshold time period, any UECS synchronization signals for the first UECS 602. At 625, the UE 111 decides to assume the role of coordinating UE for the UECS 602 and, at 630, begins periodically transmitting UECS synchronization signals for the first UECS 602 using the air interface resources allocated by the RAN 140 for UECS synchronization signals. Alternatively (not illustrated), the UE 111 can decide to discontinue participation in the first UECS 602 or continue monitoring for UECS synchronization signals from another UE in the first UECS 602 if the UE 111 is not capable (e.g., having a low remaining battery charge) of acting as the coordinating UE for the UECS 602.

At 635, the UE 114 in its role as the coordinating UE of the second UECS 604 periodically transmits UECS synchronization signals for the second UECS 604 using the air interface resources allocated by the RAN 140 for UECS synchronization signals. Although not illustrated for the sake of clarity, the UE 114 may be periodically transmitting synchronization signals for the second UECS 602 before those illustrated in FIG. 6, such as from the time it assumes the role of coordinating UE until it stops acting as the coordinating UE.

At 640, the UE 111, receives synchronization signals for the second UECS 604. Even though the UE 111 is acting as the coordinating UE for the first UECS 602, the UE 111 (and any other UEs in a UECS) may continually monitor the air interface resources allocated by the RAN 140 for UECS synchronization signals to find other UECSs operating in the vicinity.

Based on receiving the synchronization signals for the second UECS 604, the UE 111 decides to join the second UECS 604. For example, if the first UECS 602 now includes only the UE 111 and the UE 112, joining another UECS may improve the joint-communication performance for the UE 111 and other UEs in the first UECS by participating in a UECS with a greater number of UEs.

At 645, the UE 111 transmits a UECS-Handover-Request to the UE 114 to request to join the UECS 604 (e.g., to merge the first UECS into the second UECS). For example, the UE 111 includes identities of the UEs in the first UECS 602 in the UECS-Handover-Request and transmits the UECS-Handover-Request to the UE 114. At 650, the UE 114 sends a UECS-Handover-Response message to the UE 111 indicating whether or not the UE 114 has included the UEs from the UECS 602 in the UECS 604. At 655, assuming that the UECS-Handover-Response indicates the UECS-Handover-Request was accepted, the UE 111 transmits a Coordinator-Change message to the other UEs in the UECS 602. The Coordinator-Change message includes an indication that UE 114 is the coordinating UE for the UECS 604. After UEs from the first UECS 602 are included in the second UECS 604, the UEs from the first UECS 602 can be included in the round-robin schedule for coordinating UE of the second UECS 604.

### Example Method

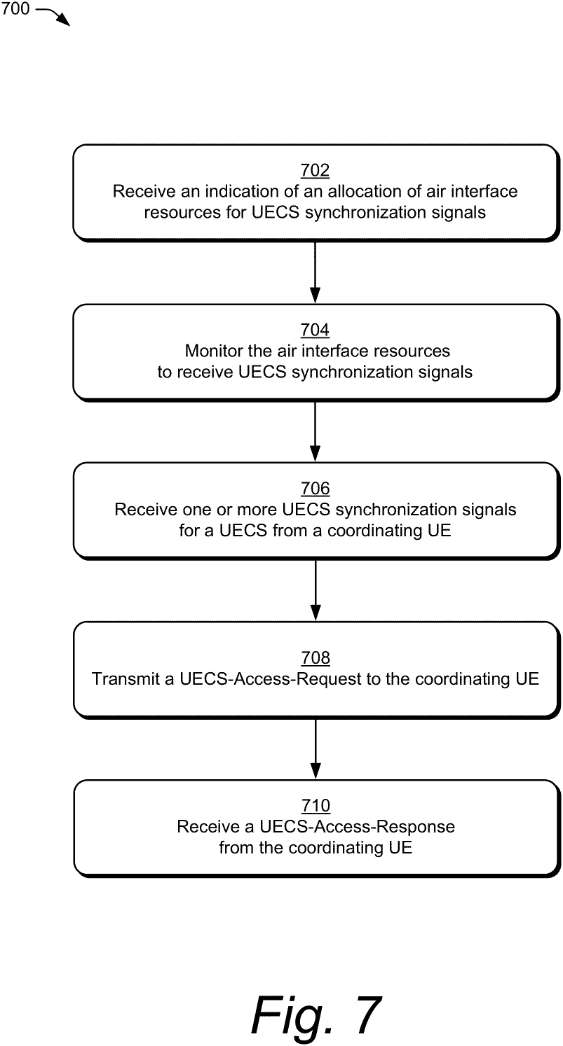

FIG. 7 illustrates example method(s) 700 of coordinating user equipment selection as generally related to scheduling UEs as the coordinating UE of the UECS. At 702, a user equipment (e.g., the UE 111) receives an indication of an allocation of air interface resources for UECS synchronization signals. For example, the RAN 140 allocates air interface resources that are used within the RAN for UECS synchronization signals. The UE may receive an indication of this allocation as broadcast information from a base station in the RAN. The air interface resources allocated for UECS synchronization signals may be in the licensed spectrum used by the RAN 140, or may be in an unlicensed radio band (e.g., an unlicensed radio band used by the local wireless network connections 133, 134 and 135).

At 704, the user equipment monitors the air interface resources to receive UECS synchronization signals. For example, the user equipment uses the LTE transceiver 206, the 5G NR transceiver 208, and/or the local wireless network transceiver 210 to attempt to receive UECS synchronization signals.

At 706, the user equipment receives one or more UECS synchronization signals for a UECS from a coordinating UE (e.g., the UE 112 in FIG. 5) for a UECS. For example, the UE receives UECS synchronization signals in one or more of the air interface resources allocated by the RAN 140.

At 708, the user equipment transmits a UECS-Access-Request to the coordinating UE. For example, the UE transmits a UECS-Access-Request message or signal to the coordinating UE to request to join the UECS.

At 710, the user equipment receives a UECS-Access-Response from the coordinating UE. For example, the UE receives a UECS-Access-Response from the coordinating UE that indicates that the coordinating user equipment has included the UE in the UECS or that the coordinating UE has rejected the request to join the UECS.

Example method 700 is described with reference to FIG. 7 in accordance with one or more aspects of coordinating user equipment selection. The order in which the method blocks are described are not intended to be construed as a limitation, and any number of the described method blocks can be skipped, repeated, or combined in any order to implement a method or an alternate method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

In the following some examples are described:

Example 1: A method for joining a first user equipment-coordination set, UECS, by a first user equipment, UE, in a wireless communications network, the method comprising the first user equipment:
receiving an indication of an allocation of air interface resources for UECS synchronization signals;
monitoring the air interface resources to receive UECS synchronization signals;
receiving, from a second UE, acting as a coordinating UE for the first UECS, one or more UECS synchronization signals for the first UECS;
transmitting a first LTECS-Access-Request to the second UE; and
receiving a first UECS-Access-Response from the second UE, the first UECS-Access-Response indicating that the first UE is included in the first UECS.

Example 2: The method of example 1, the method comprising the first UE:
receiving, from the second UE, a first Coordinator-Change message, the first Coordinator-Change message indicating that the first UE is now acting as the coordinating UE for the first UECS; and
based on receiving the first Coordinator-Change message, periodically transmitting UECS synchronization signals for the first UECS.

Example 3: The method of example 2, wherein the Coordinator-Change message includes a round-robin schedule of UEs to act as the coordinating UE for the first UECS.

Example 4: The method of example 3, wherein the round-robin schedule includes an indication of a criteria for scheduling a duration for each UE in the round-robin schedule to act as the coordinating UE, and wherein the criteria include one or more of:
a time duration;
an amount of power consumed performing coordinating UE operations; or
an amount of data transferred while acting as the coordinating UE.

Example 5: The method of example 3 or example 4, the method comprising the first UE:
based on the round-robin schedule, including an indication of a third UE acting as the next coordinating UE for the first UECS in a second Coordinator-Change message;
transmitting the second Coordinator-Change message to the UEs included in the first UECS; and
discontinuing the periodic transmission of UECS synchronization signals for the first UECS.

Example 6: The method of example 5, wherein the transmitting the second Coordinator-Change message comprises:

transmitting the second Coordinator-Change message as a broadcast message to the UEs included in the first UECS.

Example 7: The method of example 3 or example 4, the method comprising the first UE:
receiving a second LTECS-Access-Request from a fourth UE;
determining to include the fourth UE in the first UECS; and
transmitting to the fourth UE a second UECS-Access-Response, the second UECS-Access-Response indicating that the fourth UE is included in the first UECS.

Example 8: The method of example 7, the method comprising the first UE:

including the fourth UE in the round-robin schedule.

Example 9: The method of example 8, wherein including the fourth UE in the round-robin schedule comprises the first UE:
evaluating one or more selection criteria for including the fourth UE in the round-robin schedule, wherein the one or more selection criteria include:
a remaining battery charge of the fourth UE;
a charging status of the fourth UE;
an uplink signal power to a base station;
a downlink received signal strength from the base station;
an uplink transmit power to the base station;
a number of uplinks from the fourth UE to base stations; or
an uplink data throughput of the fourth UE.

Example 10: The method of example 9, wherein the one or more selection criteria are included in the second UECS-Access-Request.

Example 11: The method of example 1, the method comprising the first UE:
after receiving, from the second UE, the first UECS-Access-Response from the second UE, monitoring air interface resources to receive UECS synchronization signals from the second UE; and
determining that the UECS synchronization signals from the second UE have not been received for a threshold period of time.

Example 12: The method of example 11, the method comprising the first UE:
determining to act as the coordinating UE for the first UECS; and
periodically transmitting the UECS synchronization signals for the first UECS.

Example 13: The method of example 11 or example 12, the method comprising the first UE:
receiving UECS synchronization signals for a second UECS from a fifth UE, the fifth UE acting as a coordinating UE for the second UECS;
transmitting a third UECS-Access-Request to the fifth UE; and
receiving from the fifth UE a third UECS-Access-Response from the fifth UE, the third LTECS-Access-Response indicating that the first UE is included in the second UECS.

Example 14: The method of example 11 or example 12, wherein the first UECS includes additional UEs, the method comprising the first UE:
transmitting a UECS-Handover-Request to a fifth UE;
receiving a UECS-Handover-Response indicating that the fifth UE has included the first UE and the additional UEs into a second UECS; and
transmitting a third Coordinator-Change message as a broadcast message to the additional UEs indicating that the fifth UE is the coordinating UE for the second UECS.

Example 15: The method of example 14, comprising the first UE:

including identities of the additional UEs in the UECS-Handover-Request.

Example 16: The method of example 14 or example 15, wherein the transmitting the third Coordinator-Change message to the additional UEs comprises:

transmitting the third Coordinator-Change message as a broadcast message to the additional UEs indicating that the fifth UE is the coordinating UE for the second UECS.

Example 17: A method of example 16, the method comprising the first UE:
receiving, from the fifth UE, a third Coordinator-Change message, the third Coordinator-Change message indicating that the first UE is now acting as the coordinating UE for the second UECS; and
based on receiving the third Coordinator-Change message, periodically transmitting UECS synchronization signals for the second UECS.

Example 18: The method of any one of the preceding examples, wherein the receiving the indication of the allocation of air interface resources for the UECS synchronization signals comprises:

receiving the indication of the allocation of air interface resources for the UECS synchronization signals from a base station.

Example 19: The method of example 18, wherein the receiving the indication of the allocation of air interface resources for the UECS synchronization signals from the base station comprises:

receiving the indication of the allocation of air interface resources for the UECS synchronization signals from the base station in a broadcast message.

Example 20: The method of example 19, wherein the receiving the indication of the allocation of air interface resources for the UECS synchronization signals from the base station in a broadcast message comprises:

receiving the indication of the allocation of air interface resources for the UECS synchronization signals from the base station in a in System Information Block, SIB.

Example 21: A user equipment comprising:
a wireless transceiver;
a local wireless network transceiver;
a processor; and
instructions for a communication manager application that are executable by the processor to configure the user equipment to perform the method of any one of examples 1 to 20.

Example 22: A computer-readable medium comprising instructions that, when executed by a processor of a user equipment, cause the user equipment to perform the method of any one of examples 1 to 20.

Although aspects of coordinating user equipment selection have been described in language specific to features and/or methods, the subject of the appended claims is not necessarily limited to the specific features or methods described. Rather, the specific features and methods are disclosed as example implementations of coordinating user equipment selection, and other equivalent features and methods are intended to be within the scope of the appended claims. Further, various different aspects are described, and it is to be appreciated that each described aspect can be implemented independently or in connection with one or more other described aspects.

1. A method for joining a first user equipment-coordination set (UECS) by a first user equipment (UE) in a wireless communications network, a UECS comprising multiple UEs configured to jointly transmit and/or jointly receive data for one or more UEs of the UECS, a UECS further comprising a coordinating UE configured to coordinate joint transmission and/or reception of downlink and/or uplink data, network, the method comprising the firstUE equipment:
receiving an indication of an allocation of air interface resources for UECS synchronization signals;
monitoring the air interface resources to receive UECS synchronization signals;
receiving, from a second UE, acting as the coordinating UE for the first UECS, one or more UECS synchronization signals for the first UECS;
transmitting a first UECS-Access-Request to the second UE; and
receiving a first UECS-Access-Response from the second UE, the first UECS-Access-Response indicating that the first UE is included in the first UECS.

2. The method of claim 1, the method comprising the first UE:
receiving, from the second UE, a first Coordinator-Change message, the first Coordinator-Change message indicating that the first UE is now acting as the coordinating UE for the first UECS; and
based on receiving the first Coordinator-Change message, periodically transmitting UECS synchronization signals for the first UECS.

3. The method of claim 2, wherein the Coordinator-Change message includes a round-robin schedule of UEs to act as the coordinating UE for the first UECS.

4. The method of claim 3, wherein the round-robin schedule includes an indication of one or more criteria for scheduling a duration for each UE in the round-robin schedule to act as the coordinating UE, and wherein the criteria include one or more of:
a time duration;
an amount of power consumed performing coordinating UE operations; or
an amount of data transferred while acting as the coordinating UE.

5. The method of claim 3, the method comprising the first UE:
based on the round-robin schedule, including an indication of a third UE acting as a next coordinating UE for the first UECS in a second Coordinator-Change message;
transmitting the second Coordinator-Change message as a message to the UEs included in the first UECS; and
discontinuing the periodic transmission of UECS synchronization signals for the first UECS.

6. The method of claim 5, wherein the transmitting of the second Coordinator-Change message comprises:
transmitting the second Coordinator-Change message as a broadcast message to the UEs included in the first UECS.

7. The method of claim 2, the method comprising the first UE:
receiving a second UECS-Access-Request from a fourth UE while the first UE acts as the coordinating UE for the first UECS;
receiving a second UECS-Access-Request from a fourth UE;
determining to include the fourth UE in the first UECS; and
transmitting to the fourth UE a second UECS-Access-Response, the second UECS-Access-Response indicating that the fourth UE is included in the first UECS.

8. The method of claim 7, wherein the Coordinator-Change message includes a round-robin schedule of UEs to act as the coordinating UE for the first UECS, the method comprising the first UE:
including the fourth UE in the round-robin schedule.

9. The method of claim 8, wherein the including of the fourth UE in the round-robin schedule comprises the first UE:
evaluating one or more selection criteria for including the fourth UE in the round-robin schedule, wherein the one or more selection criteria include:
a remaining battery charge of the fourth UE;
a charging status of the fourth UE;
an uplink signal power to a base station;
a downlink received signal strength from the base station;
an uplink transmit power to the base station;
a number of uplinks from the fourth UE to base stations; or
an uplink data throughput of the fourth UE.

10. The method of claim 9, wherein the one or more selection criteria are included in the second UECS-Access-Request.

11. The method of claim 1, the method comprising the first UE:
after receiving, from the second UE, the first UECS-Access-Response, monitoring air interface resources to receive UECS synchronization signals from the second UE; and
determining that the UECS synchronization signals from the second UE have not been received for a threshold period of time.

12. The method of claim 11, the method comprising the first UE:
determining to act as the coordinating UE for the first UECS; and
periodically transmitting the UECS synchronization signals for the first UECS.

13. The method of claim 11, the method comprising the first UE:
receiving UECS synchronization signals for a second UECS from a fifth UE, the fifth UE acting as a coordinating UE for the second UECS;
transmitting a third UECS-Access-Request to the fifth UE; and
receiving from the fifth UE a third UECS-Access-Response, the third UECS-Access-Response indicating that the first UE is included in the second UECS.

14. The method of claim 11, wherein the first UECS includes additional UEs, the method comprising the first UE:
transmitting a UECS-Handover-Request to a fifth UE, the fifth UE acting as a coordinating UE for a second UECS;
receiving a UECS-Handover-Response indicating that the fifth UE has included the first UE and the additional UEs into the second UECS; and
transmitting a third Coordinator-Change message to the additional UEs indicating that the fifth UE is the coordinating UE for the second UECS.

15. The method of claim 14, comprising the first UE:
including identities of the additional UEs in the UECS-Handover-Request.

16. The method of claim 14, wherein the transmitting of the third Coordinator-Change message to the additional UEs comprises:
transmitting the third Coordinator-Change message as a broadcast message to the additional UEs indicating that the fifth UE is the coordinating UE for the second UECS.

17. The method of claim 13, the method comprising the first UE:
receiving, from the fifth UE, a fourth Coordinator-Change message, the fourth Coordinator-Change message indicating that the first UE is now acting as the coordinating UE for the second UECS; and
based on receiving the fourth Coordinator-Change message, periodically transmitting UECS synchronization signals for the second UECS.

18. The method of claim 1, wherein the receiving the indication of the allocation of air interface resources for the UECS synchronization signals comprises:
receiving the indication of the allocation of air interface resources for the UECS synchronization signals from a base station.

19. The method of claim 18, wherein the receiving of the indication of the allocation of air interface resources for the UECS synchronization signals from the base station comprises:
receiving the indication of the allocation of air interface resources for the UECS synchronization signals from the base station in a broadcast message.

20. A user equipment (UE) comprising:
a wireless transceiver;
a processor; and
instructions for a communication manager application that are executable by the processor to configure the UE to: of
receive, using the wireless transceiver, an indication of an allocation of air interface resources for user equipment-coordination set (UECS) synchronization signals, a UECS comprising multiple UEs configured to jointly transmit and/or jointly receive data for one or more UEs of the UECS, a UECS further comprising a coordinating UE configured to coordinate joint transmission and/or reception of downlink and/or uplink data;
monitor the air interface resources to receive UECS synchronization signals,
receive, from a second UE, acting as a coordinating UE for the first UECS, one or more UECS synchronization signals for the first UECS;
transmit a first UECS-Access-Request to the second UE; and
receive a first UECS-Access-Response from the second UE, the first UECS-Access-Response indicating that the first UE is included in the first UECS.
